(19) United States
(12) Patent Application Publication
(10) Pub. No.: US 2021/0162583 A1
(43) Pub. Date: Jun. 3, 2021

(54) HANDLING DEVICE

(71) Applicant: COMMISSARIAT Á L'ENERGIE ATOMIQUE ET AUX ENERGIES ALTERNATIVES, PARIS (FR)

(72) Inventors: Pierrick BUVAT, MONTBAZON (FR); Stéphane CARRIERE, VILLANDRY (FR); Laurent CHAZOT, JOUE-LES-TOURS (FR); Jérôme SERRE, PERTUIS (FR); Jean-Jacques BOUGY, GARANCIERES (FR)

(21) Appl. No.: 16/610,567

(22) PCT Filed: May 3, 2018
(86) PCT No.: PCT/FR2018/051111

§ 371 Date: Nov. 4, 2019

(30) Foreign Application Priority Data
May 3, 2017 (FR) 1753910

(51) Int. Cl. B25J 9/00; B25J 15/06; B25J 9/04

(52) U.S. Cl. CPC B25J 9/0084; H01M 8/1004; B25J 9/041; B25J 15/0616

(57) ABSTRACT

The invention relates to a fuel cell membrane handling device comprising a first membrane storage station (A1) and a receiving station (C) as well as a first manipulator (B1) comprising means (68) for gripping a membrane (12) from a free face thereof, the first manipulator (B1) being articulated so as to be capable of moving between a position for taking a membrane (12) from the storage station (A1) and a position for placing a membrane (12) in the receiving station (C). According to the invention, the receiving station (C) comprises a tray for receiving a membrane (12) comprising at least one opening (C2) wherein the gripping means (68) and a portion of the manipulator are capable of fitting into a first position for placing a membrane (12) wherein the membrane (12) is received on the receiving tray (C1).

### FIELD OF THE INVENTION

This invention relates to the field of fuel cell membrane/electrode assembling devices.

### TECHNICAL BACKGROUND

Proton exchange membrane fuel cells, known as PEMFCs, stand for “proton exchange membrane fuel cells” or “polymer electrolyte membrane fuel cells” and have particularly interesting compactness properties. Each cell includes a polymer electrolyte membrane that enables only the passage of protons and not the passage of electrons. The membrane is contacted with an anode on a first side and with a cathode on a second side to form a membrane/electrode assembly called MEA. The anode and cathode all have the same constitution and are called electrodes, the anode or cathode function being linked to its mounting in the fuel cell. Thus, the anode of the MEA is the one that receives the hydrogen flow. An electrode is a membrane comprising a first layer and a second layer that are separate from each other. The first layer is a diffusion layer formed of a carbon fabric whereon the second catalytic layer comprising a binder incorporating a catalyst such as platinum is deposited.

The above assembly is generally carried out by successive superposition of the different membranes and electrodes with an interposition of reinforcing membranes to support the assembly. More specifically, each electrode is arranged so that the second layer or active layer is arranged opposite the polymer electrolyte membrane. Thus, it should be understood that an MEA has orthogonal symmetry with respect to a plane interposed between the electrode membranes. Therefore, this symmetry of the MEA could be easily achieved by predisposing a first electrode membrane with the diffusion layer facing downwards and a second electrode membrane with the diffusion layer facing upwards, which would enable a robot manipulator to automatically take and place an electrode membrane in a correct orientation and simply move it over the other membranes.

However, it should be understood that this requires a pre-orientation of the electrode membranes which must not suffer from any errors. Otherwise, it leads to an MEA with the diffusion layer being oriented towards the polymer electrolyte membrane, with such an MEA not being usable. In addition, the successive production of MEAs would require, for example, an alternating stacking of the electrode membranes as mentioned above, which is complicated. It should be noted that gripping the electrodes at the second layer is not desirable to avoid damaging the catalytic function of the second layer.

Thus, an obvious solution would be to stack the electrode membranes one on top of the other with the first layer facing upwards, to grip the electrodes by the diffusion layer and to use conveying means enabling to alternatively position an electrode membrane with its second layer facing upwards, during a first step of producing an MEA, and another electrode membrane with its second layer facing downwards and opposite a polymer electrolyte membrane which would be interposed between the two electrodes. However, the gripping of a membrane by the diffusion layer requires a mechanical bond on said layer, making it difficult to place the diffusion layer of the gripped electrode membrane onto a support, so that the second layer is oriented upwards and enables the polymer electrolyte membrane to be received.

### SUMMARY OF THE INVENTION

This invention first of all relates to a fuel cell membrane handling device comprising a first membrane storage station and a receiving station as well as a first manipulator comprising means for gripping a membrane from a free side thereof, the first manipulator being articulated so as to be capable of moving between a position for gripping a membrane of the storage station and a position for placing a membrane on the receiving station, characterized in that the receiving station comprises a tray for receiving a membrane having at least one opening wherein the gripping means and a portion of the first manipulator are able to be fitted in a first position for placing a membrane wherein the membrane is received on the receiving tray.

According to the invention, the integration of an opening in the tray of a membrane receiving station enables a membrane to be moved from the storage station to a receiving placing position on the receiving tray without the gripping means and the arm hindering the positioning of the membrane on the receiving station.

According to another characteristic of the invention, the first manipulator is articulated so that it can take a second placing position wherein the gripping means are arranged above the receiving tray, a membrane being able to be received on the receiving tray.

In this configuration, the same manipulator can handle two separate membranes stored in the first storage station.

Advantageously, when the first storage station includes a preferably vertical stack of electrode membranes with all their diffusion layers facing upwards, the first manipulator can be articulated to be able to make a first displacement of an electrode membrane from the first storage station to a tray of the receiving station with a turning over of the electrode membrane and to be able to make a second displacement of another electrode membrane from the first storage station to the tray of the receiving station without turning over the electrode membrane. Thus, a membrane arranged substantially horizontally in the first storage magazine is moved and turned 180° and another membrane also arranged substantially horizontally in the first storage magazine is simply moved while maintaining the initial orientations of its respective faces with respect to the vertical.

Preferably, the opening of the tray is a substantially U-shaped notch.

According to another characteristic of the invention, the first manipulator comprises a connecting segment, one end of which carries the suction gripping means in rotation and the other end of which is articulated in rotation on a stationary frame.

According to yet another characteristic of the invention, the device includes a second membrane storage station and a second manipulator including means for gripping a membrane from the second storage station. The second manipulator may comprise a frame provided with a plurality of openings leading to a flat gripping face of the frame, these openings being connected to vacuum supply means.

It should be understood that the manipulators can be of the suction gripping type.

The invention will be better understood and other details, characteristics and advantages of the invention will appear when reading the following description, which is given as a non-limiting example, with reference to the attached drawings.

### BRIEF DESCRIPTION OF THE FIGURES

FIG. 1 is a schematic illustration of a first electrode/polymer electrolyte membrane/electrode assembly intended to be carried out with an installation according to the invention;

FIG. 2 is a schematic illustration of a second electrode/polymer electrolyte membrane/electrode assembly intended to be carried out with an installation according to the invention;

FIG. 3 is a perspective schematic view of the installation according to the invention;

FIG. 4 is another perspective view of the installation according to the invention,

FIG. 5 is a schematic representation of the installation according to the invention

FIG. 6 is a schematic front view in perspective of several stations of the installation according to the invention, in particular one stacking station and two membrane storage stations arranged on either side of said stacking station;

FIGS. 7 and 8 are schematic perspective views similar to FIG. 6 and along two different viewing angles;

FIG. 9 is a schematic perspective view of the stacking station and the stack securing means;

FIG. 10 is an isolated schematic view in perspective of the securing means

FIG. 11 is a schematic perspective view of a first electrode membranes storage station;

FIG. 12 is a schematic perspective view of a first manipulator of the electrode membranes;

FIG. 13 is a schematic perspective view of the first station and a separator manipulator;

FIG. 14 is a schematic perspective view of a second reinforcing membrane storage station;

FIG. 15 is a schematic perspective view of a second reinforcing membrane manipulator;

FIG. 16 is a schematic perspective view of a third manipulator mounted on a longitudinal travelling rail;

FIG. 17 is a schematic perspective view of the third manipulator of FIG. 16;

FIGS. 18 to 21 represent the steps of making a first stack of membranes;

FIGS. 22 to 24 represent the steps of making a second stack of membranes;

FIG. 25 is an illustration of a method of stacking membranes to obtain the assembly shown in FIG. 1;

FIG. 26 is a schematic illustration of the contours of the elements in FIG. 25;

FIG. 27 is an illustration of a method of stacking membranes to obtain the assembly shown in FIG. 2.

### DETAILED DESCRIPTION

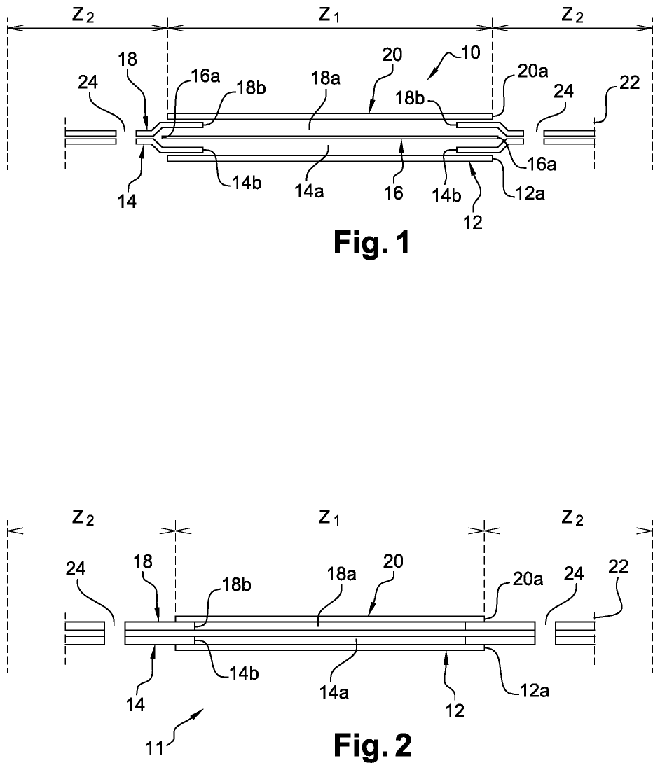

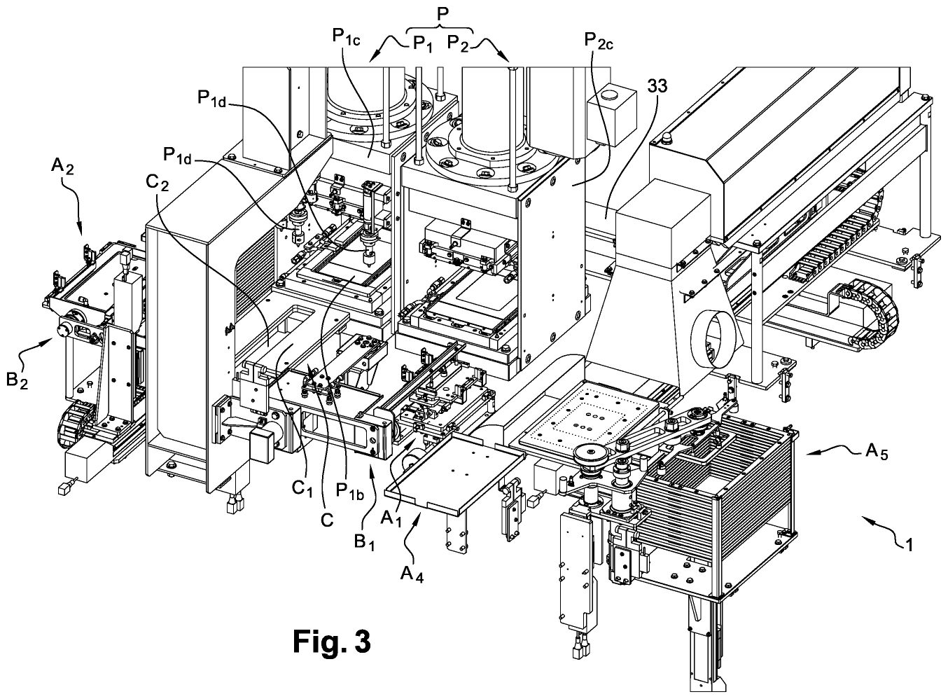

First of all, reference is made to FIG. 1, which represents a polymer electrolyte membrane/electrodes assembly 10 called MEA, intended to be obtained with the installation described in reference to FIG. 3 and following, and comprising the successive elements from bottom to top:
a first electrode 12 or lower electrode capable of forming an anode in a fuel cell,
a first membrane 14 or lower reinforcing membrane comprising an inner edge 14b defining an opening 14a closed at the bottom by the first electrode 12, the outer edge 12a of the first electrode 12 being in contact with the inner edge 14b of the first reinforcing membrane 14,
a polymer electrolyte membrane 16 ensuring proton conduction,
a second membrane 18 or upper reinforcing membrane comprising an inner edge 18b defining an opening 18a,
a second electrode 20 or upper electrode capable of forming a cathode in a fuel cell and at the top closing the opening 18a of the upper reinforcing membrane 18, the outer edge 20a of the second electrode 20 being in contact with the inner edge 18b of the second reinforcing membrane 18.

Each electrode membrane 12, 20 includes a first layer and a second layer separate from each other. The first layer is a diffusion layer formed of a carbon fabric whereon the second catalytic layer comprising a binder incorporating a catalyst such as platinum is deposited. In the arrangement shown, the second catalytic layer is arranged in contact with the polymer electrolyte membrane 16.

It should be understood that in FIG. 1, the different layers mentioned above are in contact with each other and that the gaps between said layers do not exist in a real assembly. Thus, the membrane/electrodes assembly is free of spaces or cavities inside it. In practice, the first electrode 12 and the second electrode 20 are each in contact with the polymer electrolyte membrane 16. As can be clearly seen in this figure, the polymer electrolyte membrane 16 has an outer edge 16a which is applied:
at the top on the inner edge 14b of the first reinforcing membrane 14 so as to close its opening 14a at the top,
at the bottom on the inner edge 18b of the second reinforcing membrane 18 so as to close its opening 18a at the top.

Thus, the polymer electrolyte membrane 16 is completely fitted between the first 14 and second 18 reinforced membranes and thus insulates the polymer electrolyte membrane from the cooling liquid and pure gas passages. This type of assembly is known as “anti-wicking”. More precisely, the assembly presented in FIG. 1 includes a closed contour peripheral cutout 22 forming an outer contour of the electrolyte membrane—electrodes—reinforcing membranes assembly 10. The assembly 10 also includes holes 24 between said peripheral cutout 22 and the outer edge 16a of the polymer electrolyte membrane 16, these holes 24 being intended for the passage of cooling liquid and pure gases (H₂ and O₂). In other words, these holes 24 are formed in a peripheral zone surrounding the polymer electrolyte membrane 16 and the first 12 and second 20 electrodes.

FIG. 2 shows a second assembly 11 that can be carried out with the installation described below. The stacking of the different membranes is identical to what has been described in reference to FIG. 1. However, the assembly shown in this figure does not perform an “anti-wicking” function, i.e. the polymer electrolyte membrane is not confined between the first 14 and second 18 reinforcing membranes as explained in reference to FIG. 1, but extends everywhere between the first reinforcing membrane 14 and the second reinforcing membrane 18. In practice, only the polymer electrolyte membrane 16 differs from the assembly 10 described in reference to FIG. 1.

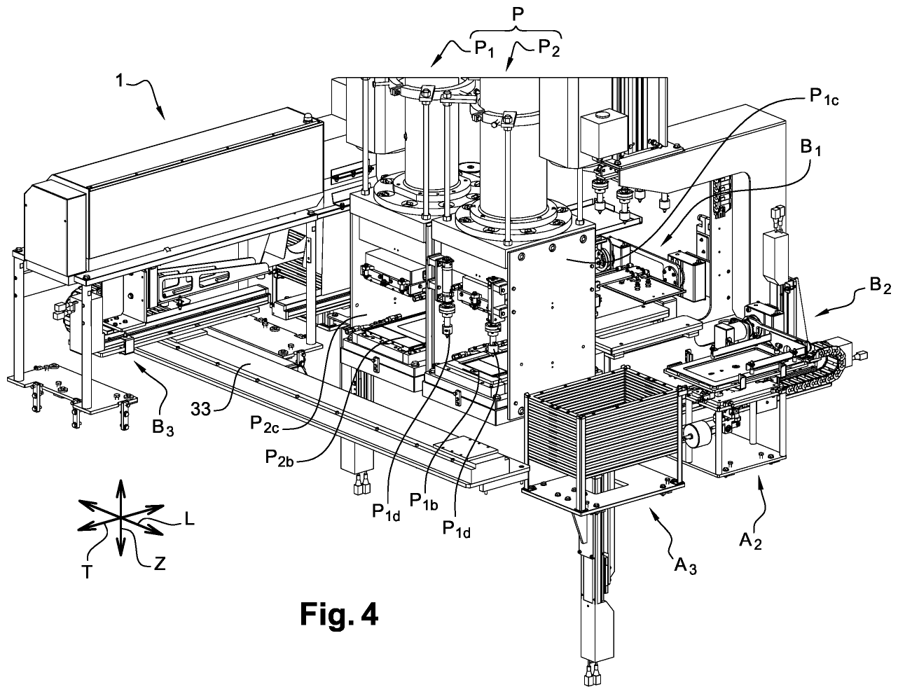

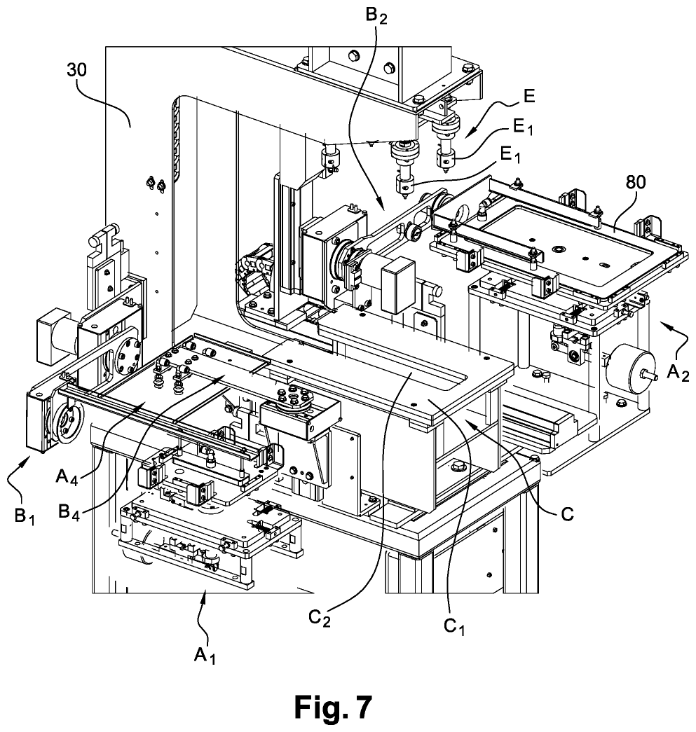

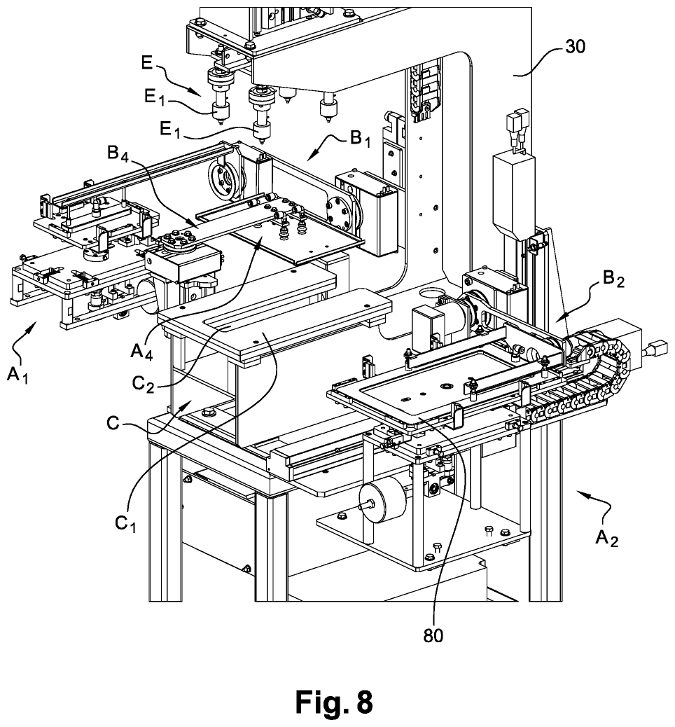

Reference is now made to FIGS. 3 to 8, which represent an installation according to the invention, with FIG. 8 being a graphical representation of the installation shown in FIGS. 3 to 7. The different units of the installation will now be described one after the other and positioned relative to each other in three perpendicular directions of the space perpendicular in pairs, namely two horizontal directions, one of which is a longitudinal direction L and the other a transverse direction T, and a vertical direction Z.

The installation 1 shown in FIGS. 3, 4 and 5 includes:
a first station A₁ for storing electrode membranes 12, 20,
a second station A₂ for storing reinforcing membrane,
a third station A₃ for storing support membrane,
a fourth station A₄ for storing separator sheets inserted between two successive electrode membranes 12, 20 of the first station A₁ for storing electrode membranes 12, 20,
a fifth station A₅ for storing a final polymer electrolyte membrane—electrode membranes—reinforcing membranes assembly as described in reference to FIGS. 1 and 2,
a sixth station A₆ for storing or recovering membrane waste,
a station C for stacking or station for receiving the membranes from the first A₁ and second A₂ storage stations,
a station P for pressing and heating a membrane assembly,
a station D for cutting an assembly 10, 11 as described in reference to FIGS. 1 and 2,
means for conveying and handling the membranes from the first station A₁, the second station A₂ and the third station A₃, a stack from the stacking station C, an assembly from the pressing and heating station P and the cutting station D.

The conveying and handling means include a plurality of manipulators i.e. five in the embodiment shown in the figures. Each manipulator includes means for gripping and placing a membrane or a plurality of membranes integral with each other.

A first manipulator B₁ is configured to enable an electrode membrane to move from the first storage station A₁ to the stacking station C. A second manipulator B₂ is configured to enable a reinforcing membrane 14, 18 to move from the second storage station A₂ to the stacking station C. A third manipulator B₃ is configured to enable a support membrane to move from the third storage station A₃ to the pressing and heating station P. A fourth manipulator B₄ is configured to enable a separator sheet to move from the first storage station A₁ to the fourth separator sheets storage station. A fifth manipulator B₅ is configured to enable a final assembly to move from the cutting station D to the fifth assemblies 10, 11 storage station A₅ and the membrane waste to move from the cutting station D to the sixth storage station A₆.

The installation 1 also includes means for securing E a stack at the stacking station C.

The pressing and heating station P consists of two presses P₁, P₂ arranged side by side in the longitudinal direction. The presses P₁ and P₂ each comprise a piston P₁ₐ, P₂ₐ arranged to move in a vertical direction opposite a press support P_{1b}, P_{2b}, the pistons and press support being carried by a press frame P_{1c}, P_{1c}. The first press P₁ provides controlled pressing, heating and cooling of the lower electrode—polymer electrolyte membrane—upper electrode stacking zone Z₁, this zone Z₁ being shown in FIGS. 1 and 2. This zone Z₁ includes all the electrodes and preferably only these. The second press P₂ provides controlled pressing, heating and cooling of a membrane stacking zone Z2 which is annular and surrounds the electrodes. This zone Z₂ is shown in FIGS. 1 and 2. This zone Z₁ includes all the electrodes and preferably only these.

The frame P_{1c} of the press P₁ carries means for securing the membranes, in this case including heating punches P_{1d} intended to be applied to the membranes.

As can be clearly seen in the figures, the stacking station C is arranged longitudinally between the first storage station A₁ and the second storage station A₂. The pressing and heating station P is arranged here in the transverse direction T between the stacking station C and a longitudinal rail 33 enabling the longitudinal displacement of the third manipulator B₃. The interest of this arrangement in relation to a support P_{1b} of the press P₁ which is accessible both ways of the transverse direction in order to enable the supply of a set of membranes from the stacking station C in a first direction of the transverse direction T on the support P_{1b} of the press P₁ and a support membrane by the manipulator B₃, at the end of the displacement, in the other way of the transverse direction T, thus enabling to have an installation 1 with reduced dimensions, will be understood later.

The pressing and heating station P is arranged longitudinally between the cutting station D and the third storage station A₃, the latter being arranged transversely opposite the second storage station A₂. Also, the stacking station C is longitudinally interposed between the first storage station A₁ and the second storage station A₂.

The station E for cutting an assembly 10, 11 as described in reference to FIGS. 1 and 2, may include laser means confined inside a hood for extracting the fumes generated through the peripheral cutting 22 and the holes 24.

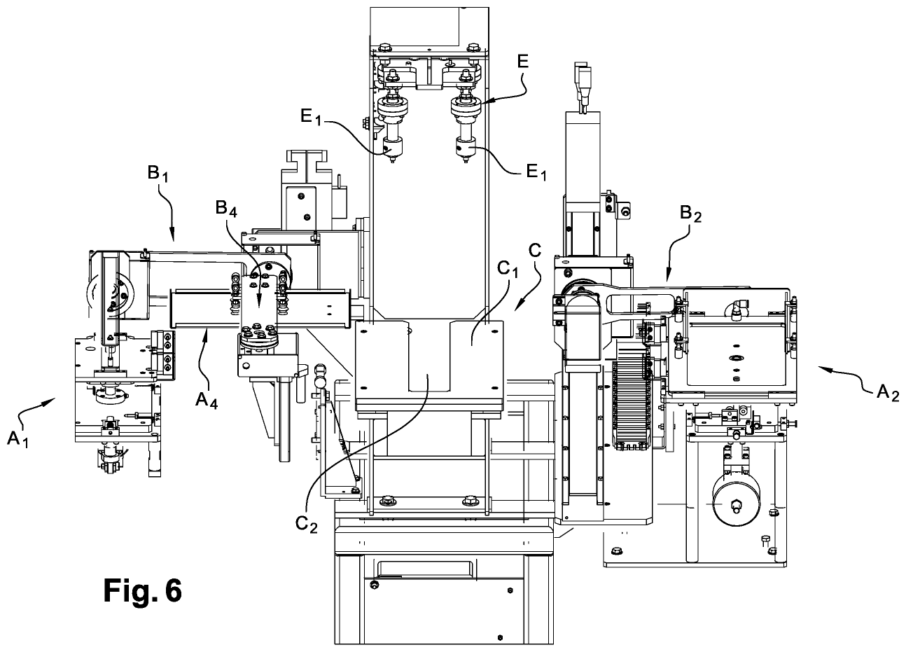

FIGS. 6 to 8 are now referred to, which represent a schematic view in perspective of the stacking station C, the first storage station A₁, the second storage station A₂ and the fourth storage station A₄. The stacking station C comprises a tray C₁ comprising an opening C₂ more precisely in the form of a U-shaped notch the function of which will clearly appear later in the description made in relation to FIGS. 21 to 24 showing the embodiment of a first stacking according to the invention. In these FIGS. 6 to 8, the first manipulator B₁, the second manipulator B₂ and the fourth manipulator B₄ are clearly visible.

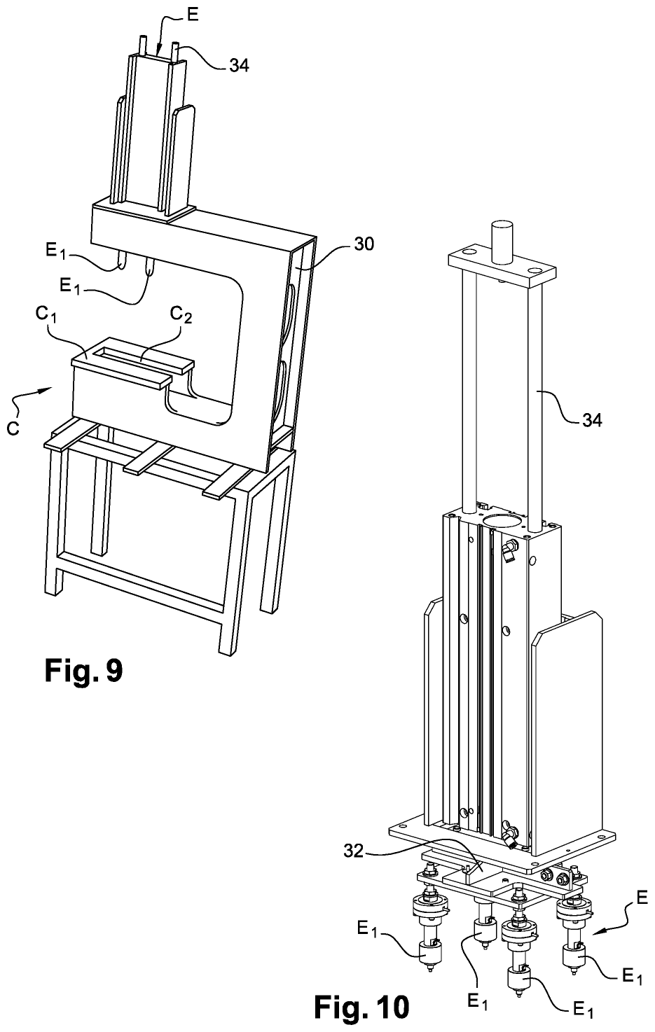

FIGS. 9 and 10 show, separately, the stacking station C comprising the stacking tray C₁ and the securing means E. The tray C₁ and said securing means E are carried by a stationary frame 30. The securing means E include heating punches E₁, for example four, enabling the welding of the membranes stacked on the stacking station C, such securing means E are carried by a base 32 secured to a slide 34 which can move in translation with respect to the support frame 30 with respect to the stacking tray C₁. To achieve the securing, the heating punches E₁ are moved until they come into contact with the stack of membranes positioned on the stacking station C. It should be understood that the punches E₁ support and heat the stack on the tray C₁. Securing is carried out between a reinforcing membrane 14, 18 and an electrode membrane 12, 20. In practice, this is done on the immediate periphery of the opening 14a, 18a with a reinforcing membrane 14, 18, preferably at the four corners of the opening 14a, 18a which has a rectangular shape.

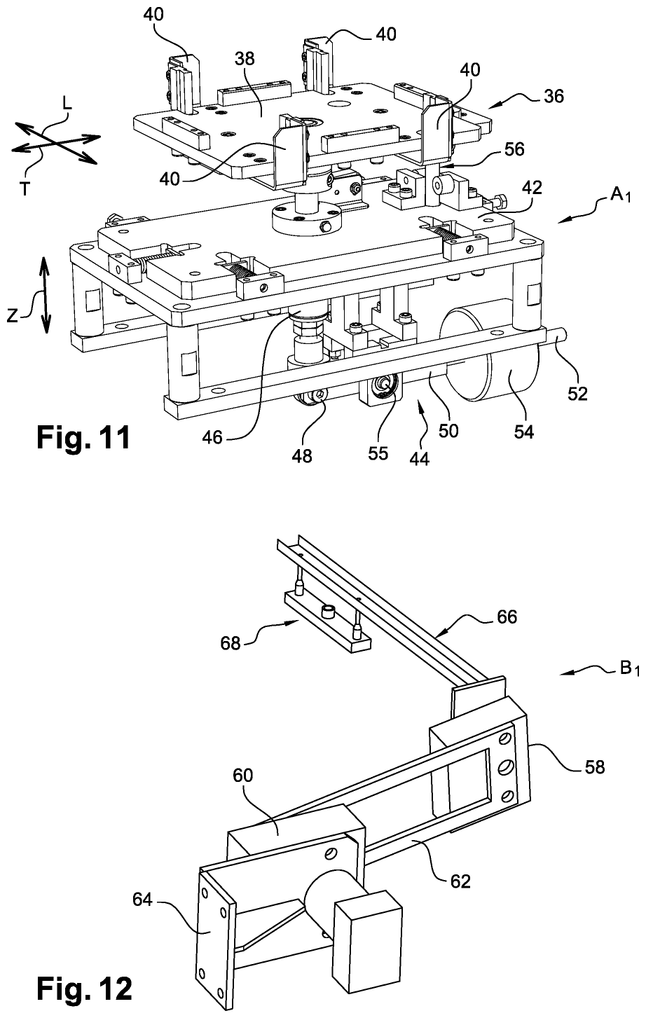

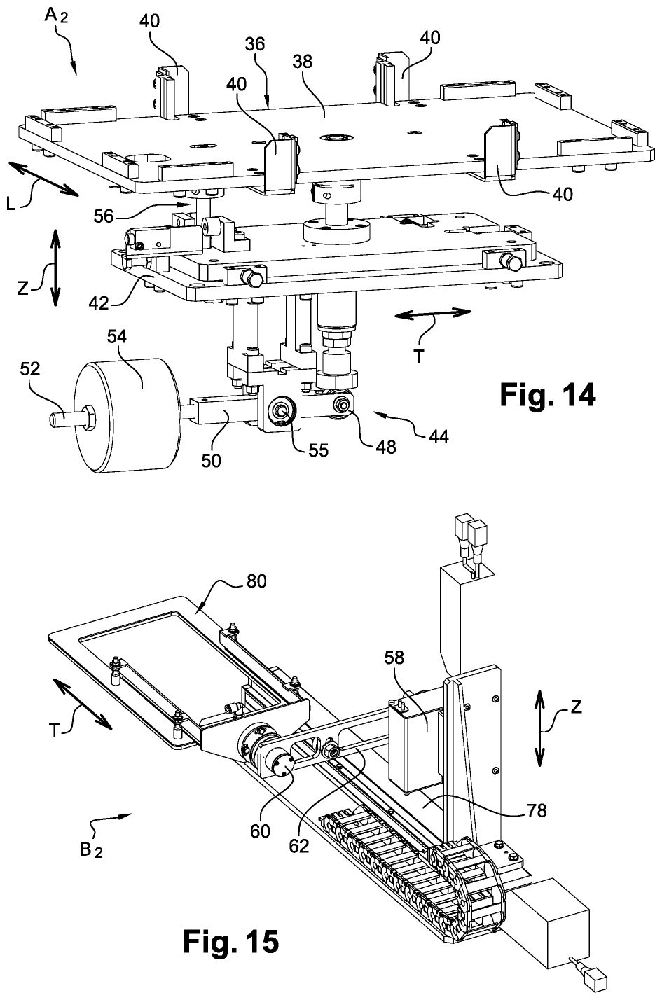

FIGS. 11 and 12 represent the first electrode membranes 12, 20 storage station A₁ and the first electrode membranes 12, 20 manipulator B₁. The first storage station A₁ includes an electrode membranes 12, 20 stack storage magazine 36 comprising a tray 38 intended to receive a stack of electrode membranes 12, 20. The edge of the tray 38 is equipped with means for positioning the electrode membranes 40 in a predetermined position. These positioning means 40 are formed by edges positioned in the format of electrodes 12, 20. The electrode 12, 20 storage magazine 36 is guided to move in a given vertical direction Z on a stationary frame 42 carrying damping and return means 44 of the magazine in a predetermined position in the absence of a bearing force exerted on the magazine in said direction by the first manipulator B₁. For this purpose, a vertical connecting rod 46 rigidly connects the tray 38 of the magazine 36 at its upper end and is rotatingly hinged at its lower end to a first end 48 of a lever 50 an opposite second end 52 of which carries a counterweight 54. The first end 48 and the second end 52 of the lever 50 are separated by a pivot 55 integral with a stationary tray 42. As can be seen in FIG. 14, the connecting rod 46 passes through the stationary tray 36 and is guided with a vertical translation through an opening in it. Thus, the stationary tray 42 is inserted between the magazine 36 and the lever 50.

Preferably, the magazine 36 is also connected to the stationary tray 42 by additional vertical translation guide means 56 of the magazine to compensate for vertical translation guide errors resulting from the sliding of the rod 46 into the opening of the stationary tray 42.

The first manipulator arm B1 advantageously comprises a first rotating joint 58 and a second rotating joint 60 connected to each other by a connecting segment 62. The two joints 58, 60 are here articulated and rotated along axes parallel to each other and extending in a transverse direction T. The first joint 58 is mounted on the frame 64 of the installation and on a first end of the segment 62 so as to articulate these relatively to each other about a first axis of rotation. The second joint 58 is mounted on the second end of the segment and on one end of a support 66 elongated in a direction parallel to the axes of rotation and carrying means for gripping and placing a membrane. These gripping and placing means 68 include suction gripping means which, in the case of the first station, advantageously include suction cups aligned in a transverse direction T and connected to vacuum supply means.

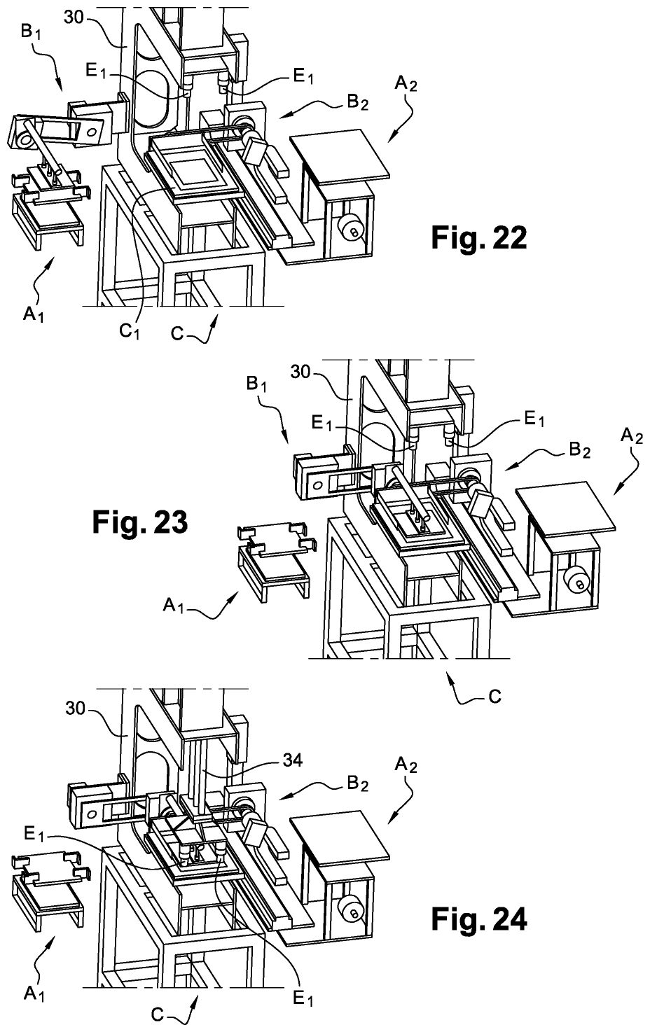

In operation, the first manipulator B₁ is capable of moving between a position in which an electrode membrane 12, 20 is taken from the electrode magazine 36 and a position in which an electrode membrane 12, 20 is placed on the tray of the stacking station C. Advantageously, a placing position corresponds to a position in which the electrode membrane 12, 20 is arranged in contact with the tray C₁ or another membrane as it will appear later, the gripping means 68 being maintained in the active state to ensure that the electrode is maintained. In practice, the first manipulator B₁ includes a first placing position and a second placing position for an electrode membrane 12, 20 on the tray C₁ of the stacking station C. In the second placing position, the first manipulator B₁ moves an electrode membrane 12 from the first storage station A₁ to the tray C₁ of the stacking station C without turning over the electrode membrane 12. In the first placing position, the first manipulator B₁ causes a second displacement of an electrode membrane 20 from the first storage station A₁ to the tray C₁ of the stacking station C with the turning over of the electrode membrane 20. In this first position, the elongated suction cup support 66 is fitted in the notch C₂ of the stacking tray C₁ as shown in FIG. 22 and as this will become clearer in relation to the description of the operation of the installation performed with reference to FIGS. 21 to 27. Also, this type of movement of the first manipulator B₁ enables a simple stacking of the electrode membranes 12, 20 in the same way in the first storage station A₁, with their first sides facing upwards so that it can be used as a gripping face while enabling an orientation of the second side carrying the catalyst downwards or upwards at the stacking station.

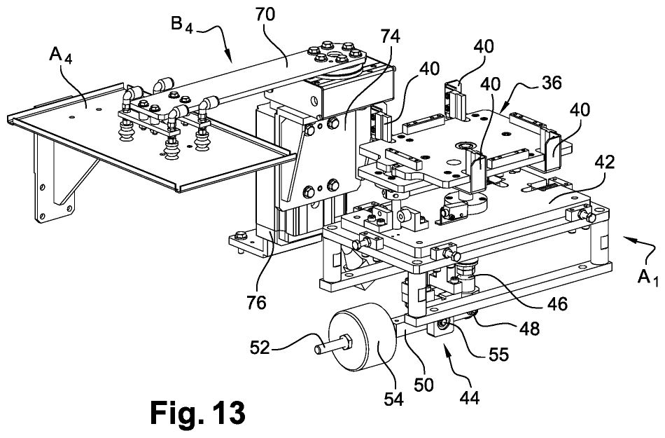

FIG. 13 shows the fourth manipulator B₄ comprising a segment 70 carrying at one end means 72 for gripping and placing a separator sheet, these means also comprising suction cups 72 connected to vacuum supply means. The segment 70 of the fourth manipulator B₄ is rotatingly articulated at its end opposite the suction cups 72 on a support 74 that can be moved vertically in relation to the frame 76 of the installation. The fourth manipulator B₄ thus enables in operation a gripping of a separator sheet and its supply to the fourth storage station A₄ of separator membranes.

FIG. 14 represents the second reinforcing membranes 14, 18 storage station A₂ which is very similar to the first storage station A₁ described in reference to FIG. 11. It will not be described again. The second manipulator B₂, visible in FIG. 15, also includes two rotating joints 58, 60 with axes parallel to each other. Unlike the first manipulator B₁, the second manipulator B₂ includes a translational displacement 78 means such as a rail sliding in the transverse direction. Also, the second rotating joint 60 carries gripping and placing means comprising suction gripping means which are, in this case, formed by a rigid frame 80 having a flat gripping face having a plurality of perforations connected to vacuum supply means. Unlike the first manipulator B₁, the second manipulator B₂ is configured to perform a displacement movement of a membrane or a set of several membranes secured to each other from the second station A₂ to the tray C₁ of the stacking station C without turning over the membrane or said set of membranes.

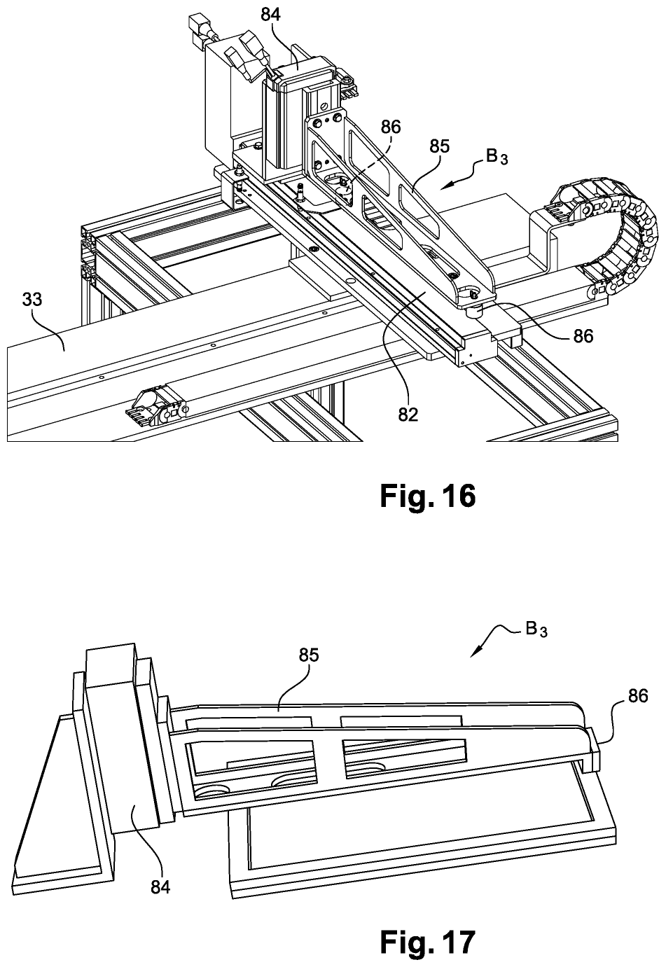

FIGS. 16 and 17 show the third manipulator B₃ comprising a transverse translation rail 82 mounted on the longitudinal rail 33. The transverse rail 82 carrying a vertical rail 84 secured to a support 85 extending in the transverse direction. In this way, the third arm B₃ can move in the three longitudinal X, transverse T and vertical Z directions of the space. The support 85 of the third arm B₃ carries magnetic gripping and placing means 86 including electromagnets activated by installation control means. These gripping and placing means are capable of gripping a metal frame from the third storage station A₃ and bringing it under the first press P₁.

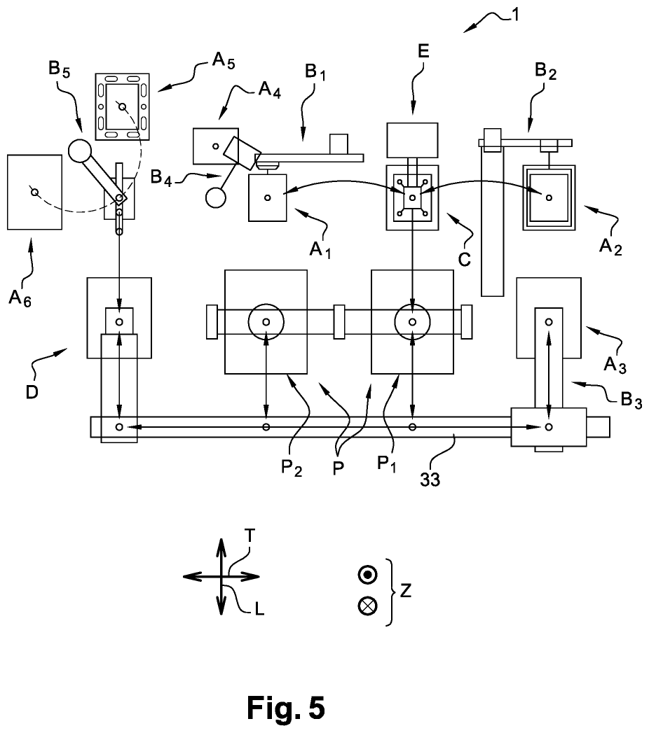

The fifth manipulator B₅ is shown in FIG. 5 and includes gripping and placing means including suction gripping means and magnetic gripping means enabling the displacement of a metal frame, in order to enable the storage of the polymer electrolyte membrane—electrode assemblies at the fifth storage station and of the metal frames at the sixth station.

The installation 1 according to the invention can advantageously be used so as to enable the production of an assembly 10 according to FIG. 1 or an assembly 11 according to FIG. 2, depending on the mode of supply of the second and third stations as has been described.

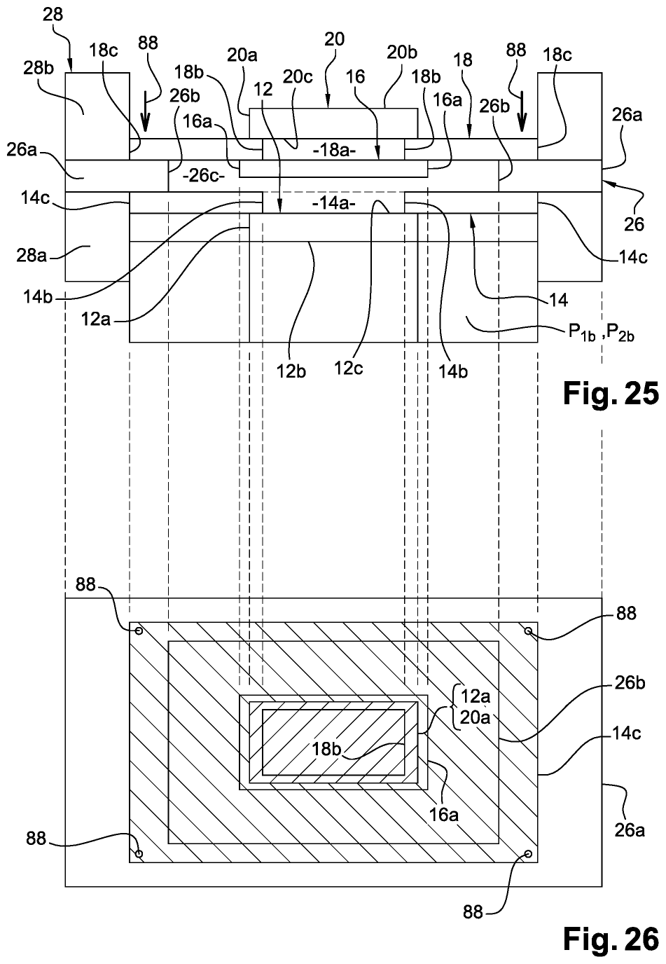

In order to obtain the assembly 10 described in reference to FIG. 1, the first storage station, the second storage station and the third storage station shall be supplied as follows:
the first storage station A₁ comprises a stacking in a vertical direction of electrode membranes 12, 20 the first diffusion layer of which is arranged upwards,
the second storage station A₂ comprises an alternation of first reinforcing membranes 14 comprising an opening 14a and second reinforcing membranes 18 comprising an opening 18a, each second reinforcing membrane 18 being secured to a polymer electrolyte membrane 16 which closes its opening and which is arranged opposite a first reinforcing membrane 12, the polymer electrolyte membrane 16 being sized so that its outer edge 16a is inscribed between the inner edges 14b, 18b and the outer edges of the first 14 and second 18 reinforcing membranes,
the third storage station A₃ comprises support membranes 26 comprising an outer edge 26a and an inner edge 26b delimiting an opening 26c of the membrane 26, this opening 26c being sized so that the polymer electrolyte membrane 16 can fit into said opening 26c and that the first reinforcing membrane 14 and the second reinforcing membrane 18 can cover the entire inner edge 26b of the support membrane 26 (FIGS. 25 and 26), each support membrane 26 being able to be clamped by its outer edge 26a between two metallic portions 28a, 28b forming a frame 28 for holding the support membrane 26 and enabling the handling thereof by the magnetic gripping means 86 of the third manipulator B₃, at least one of the portions 28a, 28b being metallic, the two portions 28a, 28b being possibly metallic.

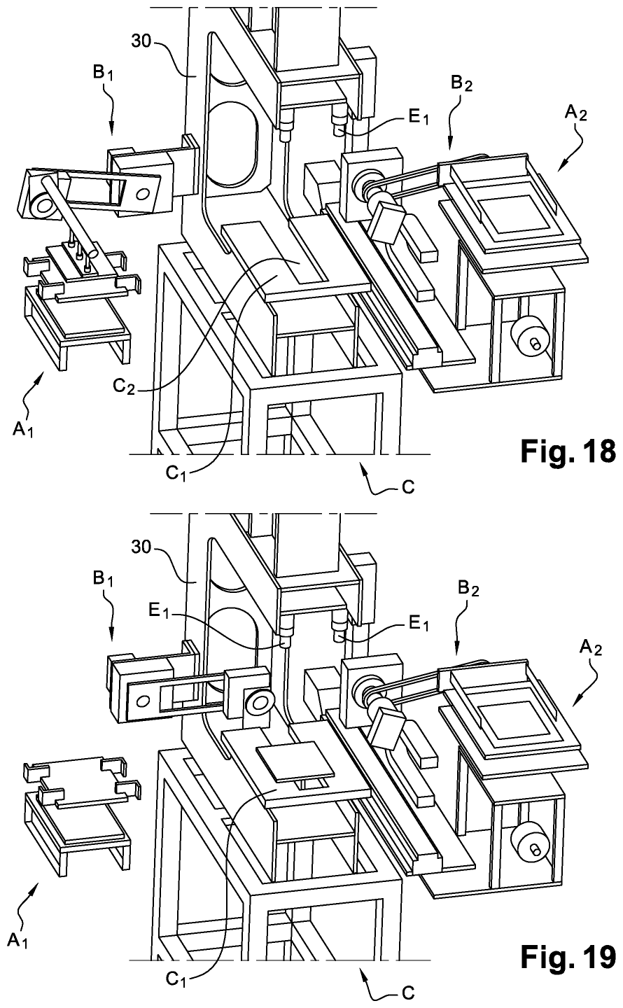

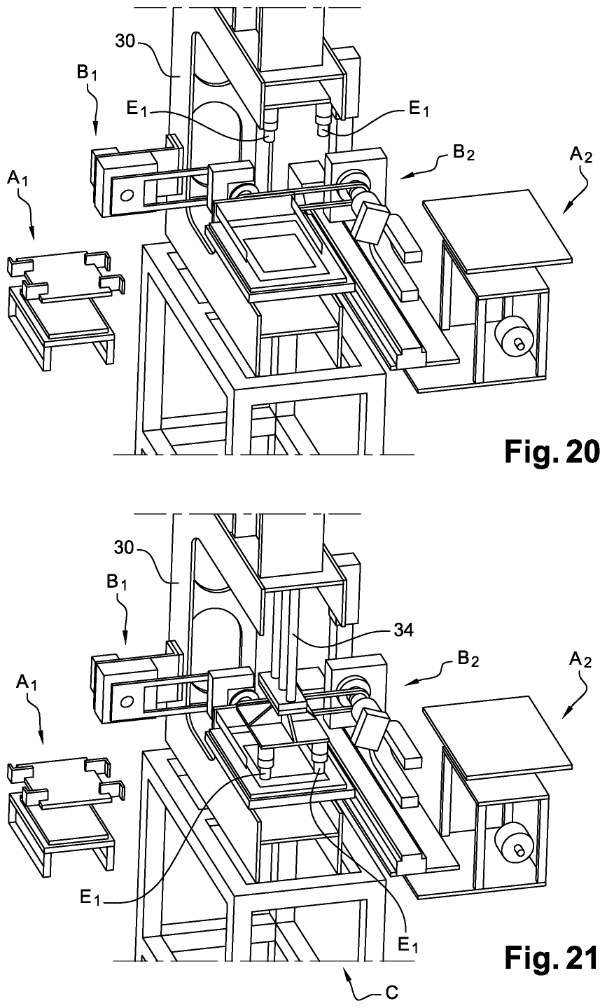

As shown in FIGS. 18 to 24, the first manipulator B₁ is operated so as to grip a first electrode 12 by its diffusion layer and then position the first manipulator arm B₁ in its first placing position on the stacking station C, with the second layer of the first electrode 12 facing upwards. In a second step, the second manipulator B₂ moves a first reinforcing membrane 14 alone from the second storage station A₂ to the stacking station C so that the opening 14a of the first reinforcing membrane 14 is closed at the bottom thereof by the first electrode 12. In a third step, the first electrode membrane 12 and the first reinforcing membrane 14 are secured together using the securing means E arranged at the stacking station C. It should be noted that the suction gripping means of the first arm B₁ and the second manipulator B₂ are kept active during the securing stage so that each membrane is secured to its manipulator. In a fourth step, the assembly thus formed is moved from the stacking station C to the press support P_{1b} using the second manipulator B₂, the suction gripping means of the first manipulator B₁ being rendered inactive whereas the suction gripping means of the second manipulator B₂ are kept in the active state so as to enable the displacement of the two membrane assembly. In a fifth step, a support membrane 26 enclosed in a metal frame 28 is brought, by means of the third manipulator B₃, onto the assembly formed by the first electrode 12 and the first reinforcing membrane 14, the inner edge 26b of the support membrane 26 being applied to the outer edge 14c of the first reinforcing membrane 14. In a sixth step, a sample is taken using the second manipulator B₂ from an assembly of a second reinforcing membrane 18 and a polymer electrolyte membrane 16, these membranes 16, 18 having previously been secured to each other. This assembly is moved on the tray C₁ of the stacking station C in a seventh step and a second electrode 20 is brought, in an eighth step, from the first storage station A₁ to the stacking station C using the first manipulator B₁ so that it closes the opening 18a of the second reinforcement 18 at the top, the first manipulator B₁ being in its second placing position. It should be noted that the suction gripping means of the first arm B₁ and the second manipulator B₂ are kept active during the securing stage. In a ninth step, the second electrode membrane 20 and the second reinforcing membrane 18 are secured together using the securing means E arranged at the stacking station C. In a tenth step, the assembly thus formed is moved from the stacking station to under the press P₁ so that the outer edge of the second reinforcing membrane 18 covers the entire inner edge of the support membrane. This step is carried out using the second manipulator B₂, the suction gripping means of the first manipulator B₁ being rendered inactive whereas the suction gripping means of the second manipulator B₂ are kept in the active state in order to enable the displacement of all the membranes. The set thus formed is shown in FIGS. 25 and 26. In an eleventh step, a controlled pressing, heating and cooling operation is carried out in zone Z₁ (shown in dotted hatches in FIG. 26) to secure the electrode membranes 23, 20 with the reinforcing membranes 14, 18 and avoid any relative movement of the membranes with respect to each other. The eleventh step of compressing and heating the electrodes can be followed by a step of securing the reinforcing membranes 14, 18 by the heating punches P_{1d} for example in a plurality, for example four, of locations 88 located at the periphery of the reinforcing membranes 14, 18 (FIGS. 25 and 26). This step can also be initiated at the end of the compression and heating cycle and ended simultaneously or after it. In other words, the step of securing by heating punches P_{1d} precedes the step of heating and compressing the annular zone Z₂. This securing step prevents the lower reinforcing membrane 14 from buckling and folding back into itself, leading to the formation of a double thickness of the reinforcing membrane 14 inducing the assembly 10 to be discarded for non-conformity. In a twelfth step, the third manipulator B₃ moves the assembly 10 onto the support P_{2b} of the press P₂ and a controlled pressing, heating and cooling operation is carried out in zone Z2 (shown in solid line hatching in FIG. 26) In a thirteenth step, the assembly is moved to the cutting station to make the peripheral edge 22 and holes 24 and then a collection of the assemblies 10 at the fifth station A5 and the metal frames 28 as well as the remains of membranes at the sixth station A6 is carried out.

It should be noted that it is possible to obtain the above-mentioned assembly with the polymer electrolyte membrane being secured to the first reinforcing membrane. In this case, it must be ensured that the first reinforcing membrane 14 and the first electrode 12 are secured before being placed on the support P_{1b} of the press P₁ by contacting the heating punches E₁ with the electrode 12 directly and not with the polymer electrolyte membrane 16 to avoid any thermal damage of the latter.

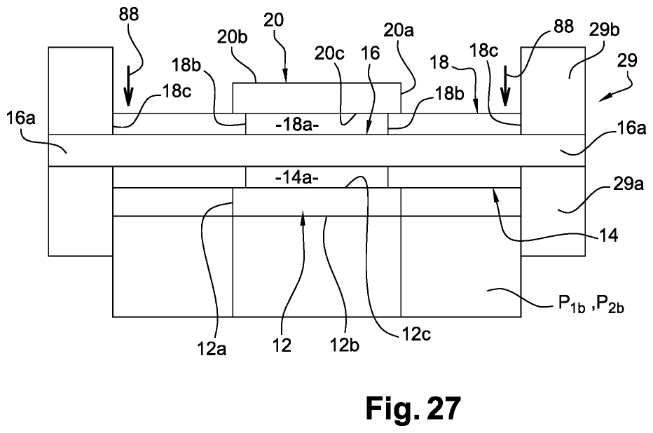

In order to obtain the assembly 11 described in reference to FIG. 2, the first storage station, the second storage station and the third storage station shall be supplied as follows:
the first storage station A₁ comprises a stacking in a vertical direction of electrode membranes 12, 20 with a diffusion layer being arranged upwards,
the second storage station A₂ comprises a plurality of reinforcing membranes 14, 18 each comprising one opening,
the third storage station A₃ comprises a stack of support membranes 12 each formed by a polymer electrolyte membrane 16 the outer edge 16a of which is clamped between two portions 19a, 29b of a metal frame (FIG. 27) forming a frame for holding the polymer electrolyte membrane 16 and enabling the manipulation thereof by the magnetic gripping means 86 of the third manipulator B3.

The same steps one to fourteen as those described above are performed, with the polymer electrolyte membrane 16 only being used as the support membrane.

It should be noted that using an elongated support 66 for the first arm makes it possible to limit the size of the U-shaped notch C₂ on the tray C₁.

In order to optimize the speed of execution of an MEA assembly, the installation includes means for controlling the conveying and handling means, these control means being configured so that the departure of a stack from the stacking station C to the pressing and heating station P is followed by a new stacking step on the stacking station C.

1.-7. (canceled)

8. A fuel cell membrane handling device comprising a first membrane storage station and a receiving station as well as a first manipulator comprising means for gripping a membrane from a free face thereof, the first manipulator being articulated so as to be capable of moving between a position for taking a membrane from the storage station and a position for placing a membrane in the receiving station, characterized in that the receiving station comprises a tray for receiving a membrane comprising at least one opening wherein the gripping means and a portion of the first manipulator are capable of fitting into a first position for placing a membrane wherein the membrane is received on the reception tray.

9. A device according to claim 8, wherein the first manipulator is articulated so that it can take a second placing position wherein the gripping means are arranged above the receiving tray, a membrane being capable of being received on the receiving tray.

10. A device according to claim 8, wherein the opening of the tray is a notch having a substantially U-shape.

11. A device according to claim 9, wherein the opening of the tray is a notch having a substantially U-shape.

12. A device according to claim 8, wherein the first manipulator comprises a connecting segment, one end of which carries the suction gripping means in rotation and the other end of which is articulated in rotation on a stationary frame.

13. A device according to claim 9, wherein the first manipulator comprises a connecting segment, one end of which carries the suction gripping means in rotation and the other end of which is articulated in rotation on a stationary frame.

14. A device according to claim 10, wherein the first manipulator comprises a connecting segment, one end of which carries the suction gripping means in rotation and the other end of which is articulated in rotation on a stationary frame.

15. A device according to claim 8, wherein it comprises a second membrane storage station and a second manipulator comprising means for gripping a membrane from the second storage station.

16. A device according to claim 9, wherein it comprises a second membrane storage station and a second manipulator comprising means for gripping a membrane from the second storage station.

17. A device according to claim 10, wherein it comprises a second membrane storage station and a second manipulator comprising means for gripping a membrane from the second storage station.

18. A device according to claim 12, wherein it comprises a second membrane storage station and a second manipulator comprising means for gripping a membrane from the second storage station.

19. A device according to claim 15, wherein the second manipulator comprises a frame provided with a plurality of holes leading to a flat gripping face of the frame, these holes being connected to vacuum supply means.

20. A device according to claim 8, wherein the gripping means are suction gripping means.

21. A device according to claim 9, wherein the gripping means are suction gripping means.

22. A device according to claim 10, wherein the gripping means are suction gripping means.

23. A device according to claim 12, wherein the gripping means are suction gripping means.

24. A device according to claim 19, wherein the gripping means are suction gripping means.
